(19) United States
(12) Patent Application Publication
(10) Pub. No.: US 2018/0141334 A1
(43) Pub. Date: May 24, 2018

(54) PRINTING SYSTEM FOR CUT SHEETS AND A METHOD THEREFOR

(71) Applicant: Océ Holding B.V., Venlo (NL)

(72) Inventors: Sander H. LOKERSE, Venlo (NL); Catharinus VAN ACQUOIJ, Venlo (NL)

(73) Assignee: Océ Holding B.V., Venlo (NL)

(21) Appl. No.: 15/808,450

(22) Filed: Nov. 9, 2017

(30) Foreign Application Priority Data
Nov. 24, 2016 (EP) 16200568.0

(51) Int. Cl. B41J 2/045; B41J 29/393

(52) U.S. Cl. CPC B41J 2/04551; B41J 2029/3935; B41J 29/393; B41J 2/04586

(57) ABSTRACT

The invention relates to a printing system 1 adapted to carry out print jobs on the basis of print job data supplied to a controller 37 of the printing system 1 and to discharge resulting printed job pages at a first job output 52. The printing system 1 comprises a sheet scheduler 373 configured to schedule test pages during the printing of the print jobs. The sheet scheduler 373 is configured to adapt a time schedule for printing the test pages to a content type 401 of each page of each print job.

The present invention relates to a printing system adapted to carry out print jobs on the basis of print job data supplied to a controller of the printing system and to discharge printed job pages at a first job output, the printing system comprising a sheet scheduler configured to schedule test pages during the printing of the print jobs.

In a printing system some kind of print inspection means is present to measure and guarantee a quality of the job pages printed by the printing system. Depending on the print technology used several different kinds of print defects may occur that may render the output of the printer of insufficient value to a customer. Such an output may be discarded and regarded as waste. In case of an inkjet printer a print defect may be streakiness in images of content due to a nozzle failure, streakiness at print head transitions or color deviations in the printed job pages due to print head registration errors, or a color deviation due to a change in an ink property.

In order to counter these print effects the printing system may be equipped with a vision system capable of detecting these print effects. A test page designed for detection of print defects is printed at a predetermined frequency, for example 1 test page in a 100 printed job pages. Test patterns on the printed test page are scanned by the vision system and analyzed by a scan processor module.

The test pages printed to measure an output quality may be separated from the normal print job pages, i.e. the printed test pages may be delivered at a second job output of the printing system.

The more responsive the printing system has to be to detect and correct print defects the more frequent the test pages have to be printed. However, the amount of printed test pages that will be wasted will also increase, which is not desirable.

Hereinafter the terms “page” and “sheet” have the same meaning, namely being a piece of media upon which print data is intended to be printed.

It is an object of the invention to provide a printing system that permits to print test pages in such a way that the amount of waste due to the printed test pages diminishes.

In order to achieve this object, according to the invention, the sheet scheduler is configured to adapt a time schedule for printing the test pages to a content type of each page of each print job.

The sheet scheduler is configured to discern for each page of a print job to be printed which content type is printed on said page. The adaption of the time schedule depends on the content type. For example, pages with a content type named “text only” may have a lower output quality requirement than pages with a content type named “graphics” comprising graphical art objects.

On the other hand, pages with content type “text only” containing financial content may have a high output quality requirement. The kind of content may be divided in an arbitrary number of categories which each have a different quality requirement.

The time schedule is adapted to the content type to be printed. The adaption may be an increase or a decrease of the interval of the printing of the test pages for the content type. Such an adaption may be done during job preparation and submission by assigning a content type but may also be done automatically by analyzing print job content.

According to an embodiment the controller is configured to determine a content type for each page of each print job by means of the print job properties.

At submission of a print job to the printing system the print job properties are known to the printing system, especially to the controller of the printing system. A print job property may be a print mode at which the print job is going to be printed, for example an economy mode, a presentation mode, a high quality mode, etc. Such a print job property is used during the determination of the time schedule for the test pages for such a print job.

According to an embodiment the controller comprises a raster image processor for rasterizing pages of the print jobs and the controller is configured to determine a content type for each page of each print job by means of rasterized images of the pages of the print job. The rasterized images—which are rasterized before the actual printing of the corresponding pages—are analysed and a content type of each image is determined.

According to an embodiment the printing system comprises an inline vision system positioned between a print engine and the second job output and configured to capture images of the printed job pages and printed test pages, and the controller is configured to analyse content of captured images of recently printed job pages in order to determine a content type of printed job pages scheduled between recently printed test pages and the scheduler is configured to use the determined content type of the printed job pages scheduled between the recently printed test pages to determine the time schedule for next test pages. A test page print interval is automatically adjusted based on the determined job content. The scheduler may increase the test page interval when text only content is detected in order to reduce an amount of waste generated by printed test pages. The scheduler may decrease the test page interval again when graphics content is detected.

According to an embodiment the scheduler is configured to determine a moment in time to start with printing test pages according to the determined time schedule by taking into account a time period which is needed to determine the content type of the print jobs and to prepare correcting actions due to the analysis of the content of the captured images before an actual printing of the job pages with a new content type starts. For example, if the inline vision system detects a failing nozzle of the print head, a compensation of the failing nozzle by a neighboring nozzle may be started after a certain time delay. When a content type switch is known for the next print job pages from pages of a first content type to a second content type, a moment in time for printing a test page is scheduled at least so far before the time moment of the content type switch as the delay is taking in time.

According to an embodiment the controller is configured to determine a content type of a job page by means of at least one color of content of the job page. A print job comprising a color page may have a higher output quality requirement than a print job having only black-and-white pages. When submitting a print job such a color mode is often entered in a submission tool for the print job. An inline vision system is also able to detect colors in the job pages printed so far. A raster image processor is also able to determine colors in the job pages to be printed.

According to an embodiment the scheduler is configured to determine the time schedule for printing the test pages by taking into account an amount of detected print defects from images captured from the already printed test pages. For example, if the number of print defects on the printed test pages increases, an interval of the printing of the test pages may be temporarily increased until the number of print defects diminishes after a while, for example after a cleaning action on the print head of the printing system.

According to an embodiment the scheduler comprises memory containing a frequency of printing test pages per content type in order to establish the time schedule for printing the test pages per content type. The memory may for example comprise a look up table for an established content type and a corresponding test page frequency which is to be used to schedule the test pages of such a content type.

According to an embodiment the printing system comprising a user interface adapted to receive a dedicated frequency of printing test pages for each content type, the dedicated frequency entered by a user of the printing system at the user interface. This is advantageous, since the user has a possibility to overrule a time schedule based on a test page print interval for a certain content type which is otherwise automatically determined by the scheduler. For example, for a print job with special customer needs a deviating frequency may be entered by the user at a screen of the user interface.

According to an embodiment the sheet scheduler is configured to adapt a time schedule for printing the test pages to a media type of each page of each print job. For example, pages to be printed on a media type of low cost may have a lower output quality requirement than pages to be printed on an expensive media type. A time interval for printing test pages on an expensive media type may be determined to be smaller than a time interval for printing test pages on a media type of low cost.

At submission of a print job to the printing system the print job properties are known to the printing system, especially to the controller of the printing system. A print job property is the media type on which the pages of the print job are intended to be printed. The media type of a test page for a print job may be derived from the print job properties.

According to an embodiment the printing system comprises a second job output configured to discharge resulting printed test pages. By using the second job output the test pages are immediately separated from the print job pages discharged to the first job output.

The invention also relates to a method for scheduling test pages on a printing system adapted to carry out print jobs on the basis of print job data supplied to a controller of the printing system and to discharge resulting printed job pages at a first job output, the printing system comprising a scheduler configured to schedule test pages during the printing of the print jobs, the method comprising the steps of determining a content type of each page of each print job, determining a time schedule for printing the test pages, the time schedule based on the determined content type each page of each print job, and printing the test pages according to the determined time schedule by the printing system.

The invention also relates to a non-transitory recording medium comprising computer-executable program code configured to instruct a controller of a printing system according to the invention and a computer to perform a method according to the invention.

Preferred embodiments will now be described in conjunction with the drawings, wherein:

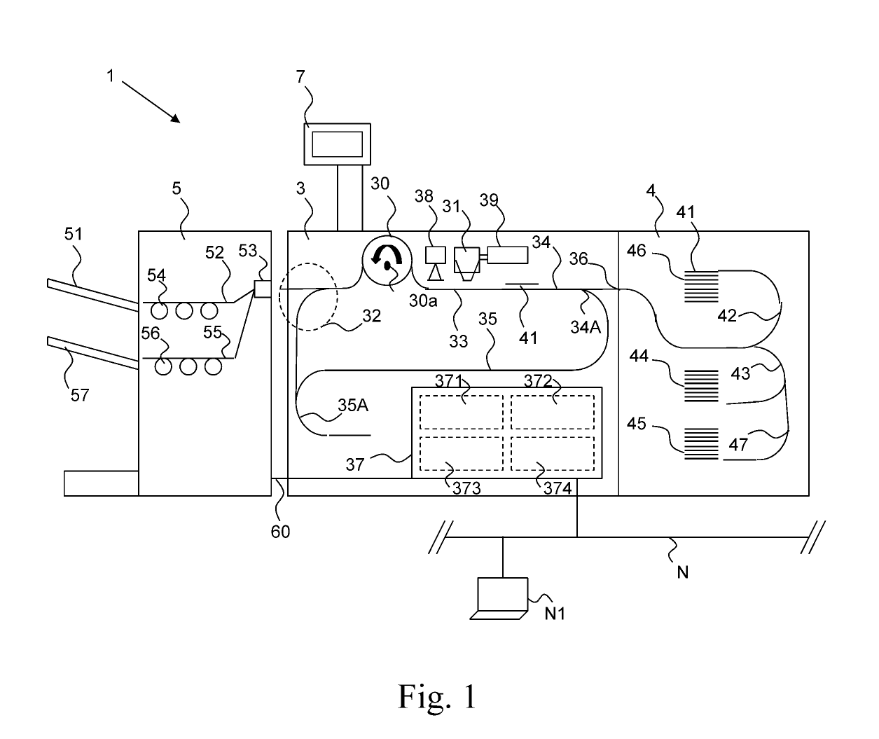

FIG. 1 is a schematic view of the printing system according to the invention;

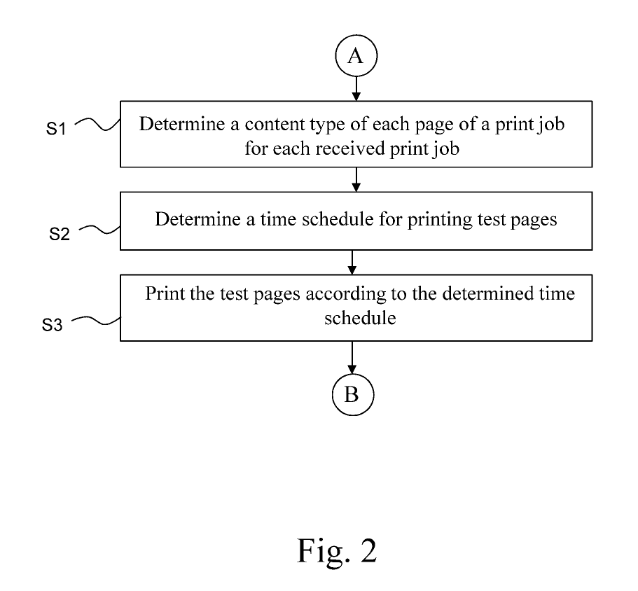

FIG. 2 is a flow diagram of an embodiment of the method according to the invention;

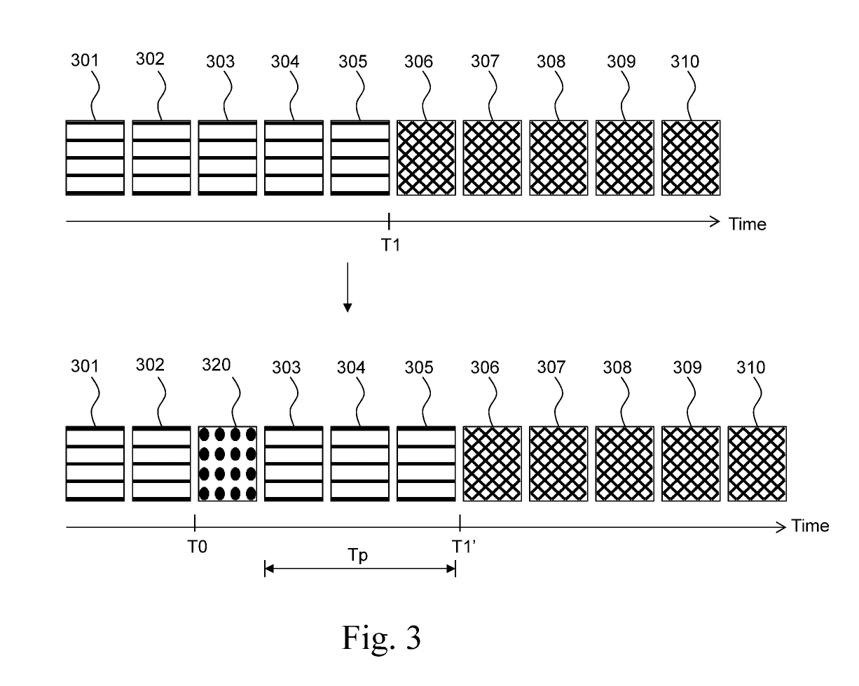

FIG. 3 is a schematic view of a test page scheduled according to the invention between pages of print jobs having different content types; and

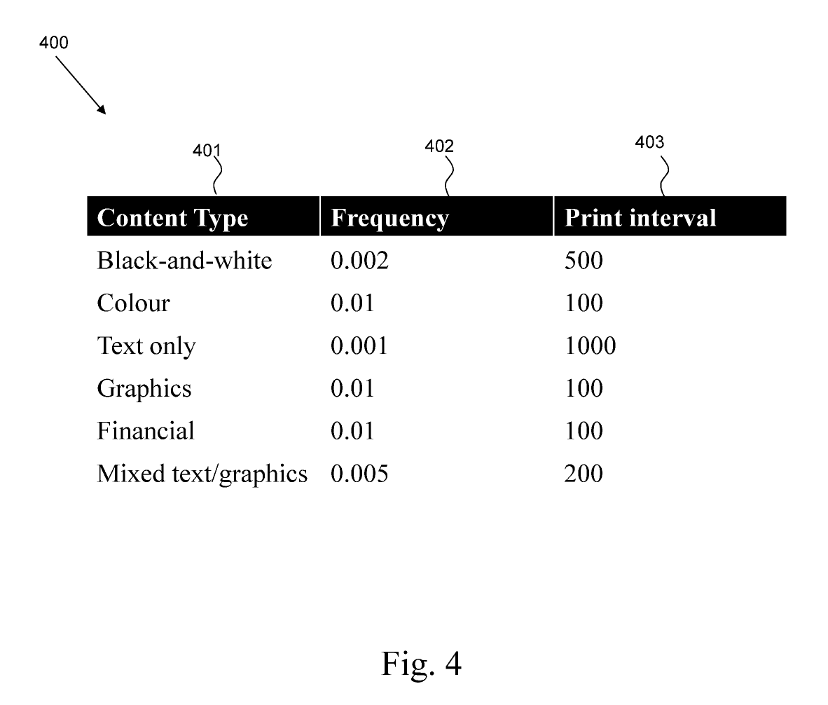

FIG. 4 is a schematic look up table comprising frequencies and/or print intervals for pages per content type.

FIG. 1 shows schematically an embodiment of a printing system 1 according to the invention. The printing system 1, for purposes of explanation, is divided into an output section 5, a print engine and control section 3, a local user interface 7 and an input section 4. While a specific printing system is shown and described, the disclosed embodiments may be used with other types of printing system such as ink jet, electrographic, etc.

The output section 5 comprises a first output holder 52 for holding printed image receiving material, for example a plurality of sheets specified by a print job. The output section 5 may comprise a second output holder 55 for holding printed test pages, but printed test pages may also be discharged at the first output holder 52. The printed image receiving material is transported from the print engine and control section 3 via an inlet 53 to the output section 5. When a stack ejection command is invoked by a controller 37 for the first output holder 52, first guiding means 54 are activated in order to eject the plurality of sheets in the first output holder 52 outwards to a first external output holder 51. When a stack ejection command is invoked by the controller 37 for the second output holder 55, second guiding means 56 are activated in order to eject the plurality of sheets in the second output holder 55 outwards to a second external output holder 57.

The output section 5 is digitally connected by means of a cable 60 to the print engine and control section 3 for bi-directional data signal transfer.

The print engine and control section 3 comprises a print engine 31 and a controller 37 for controlling the printing process and scheduling the plurality of sheets 41 corresponding to pages specified in a print job in a printing order before they are separated from input holder 44, 45, 46. The print engine 31 processes bitmaps received from a raster image processor 374 into halftoned bitmaps suitable for printing by the print engine 31.

The controller 37 is a computer, a server or a workstation, connected to the print engine 31 and connected to the digital environment of the printing system, for example a network N for transmitting a submitted print job to the printing system 1. In FIG. 1 the controller 37 is positioned inside the print engine and control section 3, but the controller 37 may also be at least partially positioned outside the print engine and control section 3 in connection with the network N in a workstation N1.

The controller 37 comprises a print job receiving section 371 permitting a user to submit a print job to the printing system 1. The print job comprises pages with content to be printed and a plurality of print job settings. The controller 37 comprises a print job queue section 372 comprising a print job queue for print jobs submitted to the printing system 1 and scheduled to be printed. The controller 37 comprises a sheet scheduler 373 for determining for each of the plurality of sheets corresponding to pages of the print jobs in the print job queue an entrance time in the paper path of the print engine and control section 3. The sheet scheduler 373 may also be a software or hardware component positioned distinctly from the controller 37 but digitally connected to the controller 37. The controller 37 comprises a raster image processor 374 for translating the page description of a page of the print job into bitmaps to be fed to the print engine 31. During the translation process the raster image processor 374 may determine a content type of the page which is passed to the sheet scheduler 373.

The sheet scheduler 373 is configured to schedule test pages during the printing of the print jobs. The sheet scheduler 373 may be configured to discharge resulting printed test pages at a second output holder 55 when present.

Resources are sheets 41 of media type material located in the input section 4, marking material located in a reservoir 39 near or in the print head or print assembly 31 of the print engine, or finishing material located near the print head or print assembly 31 of the print engine or located in the output section 5 (not shown).

The paper path comprises a plurality of paper path sections 32, 33, 34, 35 for transporting the sheets 41 from an entry point 36 of the print engine and control section 3 along the print head or print assembly 31 to the inlet 53 of the output section 5. The paper path sections 32, 33, 34, 35 form a loop. The loop enables the printing of a duplex print job and/or a mix-plex job, i.e. a print job comprising sheets intended to be printed partially in a simplex mode and partially in a duplex mode.

The print head or print assembly 31 is suitable for disposing marking material to the sheets 41. The print head or print assembly 31 is positioned near the paper path section 34. The print head or print assembly 31 may be an inkjet print head, a direct imaging toner assembly or an indirect imaging toner assembly.

An inline vision system 38 is positioned in between the print head or print assembly 31 and a dryer unit 30 and is directed towards the paper path section 34. The inline vision system 38 comprises scan unit like a camera or a capturing sensor which captures images from the sheets passing along the inline vision system 38 on the paper path section 34. The inline vision system 38 also comprises a scan processor which analyzes images captured from the sheets, i.e. job sheets and test sheets. For test sheets the scan processor translates the images into quantifiable image quality aspects like registration errors, jet angle errors, color differences, etc. For job sheets the scan processor may define a content type and/or extract image quality defect like streaks etc. The scan processor sends the analysis results to the controller 37.

While a sheet is transported along the paper path section 34 in a first pass in the loop, the sheet receives the marking material through the print head or print assembly 31. Directly downstream of the print head or print assembly 31 the rotational functional unit 30 is situated, for example, a fixation drum, a fixation belt, a fixation device, a drying device for drying the marking material deposited by the print head or print assembly 31 on the sheets, a drying drum, a drying belt, a fusing device, a fusing belt, a fusing drum, etc. The rotational functional component 30 may have a cylindrically shaped surface or any other rotatable surface around an axis 30a perpendicular to the drawing of FIG. 1. The surface may be an endless surface. The circumference is circular, ellipsoidal, belt-shaped. The rotational functional component has at least one rotational axis. The surface is configured to fix the marking material to the sheet or to dry the marking material on the sheet. The sheet is taken up at the right side of the rotational functional component 30 and turned to the left side of the rotational functional component 30. A next paper path section 32 is a flip unit 32 for selecting a different subsequent paper path for simplex or duplex printing of the image receiving material.

In case of duplex printing on a sheet, the sheet is transported along the loop via paper path section 35A comprising a sheet reversing mechanism in order to turn the sheet for enabling printing on the other side of the sheet. The sheet is transported along the paper path section 35 until it reaches a merging point 34A at which sheets entering the paper path section 34 from the entry point 36 interweave with the sheets coming from the paper path section 35. The sheets entering the paper path section 34 from the entry point 36 are starting their first pass along the print head or print assembly 31 in the loop.

The sheets coming from the paper path section 35 are starting their second pass along the print head or print assembly 31 in the loop. When a sheet has passed the print head or print assembly 31 for the second time in the second pass, the sheet is guided along the rotational functional component 30 and is further transported to the inlet 53 of the output section 5.

The input section 4 may comprise at least one input holder 44, 45, 46 for holding the image receiving material before transporting the sheets 41 of image receiving material to the print engine and control section 3. Sheets 41 of image receiving material are separated from the input holders 44, 45, 46 and guided from the input holders 44, 45, 46 by guiding means 42, 43, 47 to an outlet 36 for entrance in the print engine and control section 3. Each input holder 44, 45, 46 may be used for holding a different kind of image receiving material, i.e. sheets having different media properties.

The local user interface 7 is suitable for displaying user interface windows for controlling the print job queue residing in the print job queue section 372 of the controller 37. For each print job submitted to the print job receiving section 371 of the controller 37 print job properties of the submitted print job may be displayed and edited on a user interface window of the local user interface 7. According to another embodiment the computer N1 in the network N has a user interface for displaying and controlling the print job queue of the printing system 1.

FIG. 2 shows a flow diagram of an embodiment of the method according to the invention. The method is suitable for time scheduling a plurality of test pages on sheets 41 in a printing system according to FIG. 1.

The method starts in starting point A and leads to a first step S1.

In the first step S1 a content type of each page of each print job is determined by the controller 37.

According to an embodiment the controller 37 receives a print job and derives from the print job properties of a received print job a content type of each page of the print job. For example, if a print job property is a property indicating a black-and-white print job, the content type may be determined to be a content type named “black-and-white”. For example, if a print job property is a property indicating a color print job, the content type may be determined to be a content type named “color”. For example, if the print job property is a book print option, the content type may be a content type named “book print”. The determined content type per page is transferred to the sheet scheduler 373.

According to another embodiment the raster image processor 374 of the controller 37 rasterizes pages of the print jobs and the controller 37 determines a content type for each page of each print job by means of rasterized images of the pages of the print job. The digital pages of the print job are rasterized before the actual printing of the corresponding pages on sheets 41. An analysis of the rasterized pages leads to a content type for each digital page. During the analysis an amount of characters on a page, a number of graphical objects and a page area that is covered by the characters and the graphical objects is determined. Furthermore a number of digits within the detected characters may be counted. If the number of characters is high compared to the number of graphical objects, and the number of graphical object represent a low page coverage, the content type may be classified as “text only” or may be classified as “book print”. If the number of digits is high compared to the number of characters the content type may be classified as content type “financial”. A high number of graphical objects representing a high page coverage may be classified as content type “graphics”. From the analysis of a rasterized page a number of colors may be derived which are present in the rasterized page to be printed. A content type of the page may be determined based on the derived number of colors.

The controller 37 transfers the content type of each page to the sheet scheduler 373.

According to another embodiment the determination of the content type takes place after print job pages have been printed on sheets by the print engine or print assembly 31 of the printing system 1. The inline vision system 38 positioned between the print engine or print assembly 31 and the second job output holder 55 captures images of the sheets being printed job pages and printed test pages and transfers the images to the controller 37. The controller 37 may analyse content of captured images of recently printed sheets in order to determine a content type of sheets 41 scheduled between recently printed test pages. The determined content type per sheet is transferred to the sheet scheduler 373 which uses the determined content type per sheet to determine the test print interval for next test pages. A test page print interval is automatically adjusted based on the determined job content. The sheet scheduler 373 may increase the test page interval when sheets with content type “text only” are detected and so reduce an amount of waste generated by test pages. The sheet scheduler 373 may decrease the test page interval again when sheets with content type “graphics” are detected.

According to another embodiment the user interface 7 adapted to receive a frequency or a print interval of printing test pages dedicated for each content type. The dedicated frequency or print interval may be entered by a user of the printing system 1 at the user interface 7. According to an alternative embodiment the user enters the frequency or time interval per submitted print job visible on a window of the user interface 7.

In a second step S2 a time schedule is determined by the sheet scheduler 373 for printing the test pages. The time schedule is based on the determined content type of each page of each print job.

According to an embodiment the sheet scheduler 373 determines a moment in time to start with printing test pages according to the determined time schedule by taking into account a time period which is needed to determine the content type of the print jobs and to prepare correcting actions due to the analysis of the content of the captured images before an actual printing of the job pages with a new content type starts.

FIG. 3 shows an example of sheets 301-310 scheduled to be printed. The content type of each of the sheets 301-310 has already been established by the controller 37. The content type of the sheets 301-305 and even previously scheduled and already printed sheets (not shown) is for example “text only”. The frequency for content type named “text only” may be for example 0.001, i.e. a test page is printed once during 1000 printed sheets of the same content type “text only”. The sheets 306-310 have another content type, for example content type named “graphics”, and are scheduled to start printing at a moment in time T1. The frequency for a content type named “graphics” may be for example 0.01, i.e. a test page is printed once during 100 printed sheets of the same content type “graphics”. A preparation time Tp of correcting actions due to possible found print defects during an analysis of the content of the captured image of a test sheet 320 printed before actual printing of the sheets 306-310 may for example cost a print time corresponding to the printing of three consecutive sheets 303-305. The preparation time depends also on the distance a sheet has to bridge from the print engine 31 to the inline vision system 38 along the paper path 34.

It is not strictly necessary that the test sheet 320 has the same media type as the sheets 306-310. However, there may be a minimum requirement on media quality. For example, if sheets 301-305 are printed on a low quality media, then it is preferable to use the same media type as the media type of the sheets 306-310 for the test sheet 320. If color deviations are to be detected, it is preferred to use the same media type.

Therefore, according to an embodiment the method according to the invention comprises the steps of adapting the time schedule for printing the test sheets to a media type of each page of each print job, scheduling a first number of job sheets 301-305 of a first media type and consecutively a second number of job sheets 306-310 of a second media type, and scheduling within the first number of job sheets 301-305 between job sheet 302 and job sheet 303 a test sheet 320 of the second media type.

The test sheet 320 is planned by the sheet scheduler 373 to be printed between the second sheet 302 and the third sheet 303 at moment in time T0. The start time of printing the sheets 306-310 is shifted forward in time—postponed—from moment in time T1 to moment in time T1′. By doing so, it is possible to take measures in order to avoid or compensate for possibly detected print defects before the actual printing of the sheets 306-310 that comprise the new content type. The test page 320 is scheduled the first in a row of test pages which have a frequency which matches with the content type “graphics” of the sheets 306-310.

According to an embodiment the controller 37 stores an amount of detected print defects from images captured from the already printed test page and the sheet scheduler 373 takes into account the amount of detected print defects when determining the frequency or time interval for the future test pages. For example, when a number of defects are detected from analysis of the printed test page 320, the sheet scheduler 373 may schedule a first amount of test pages at a higher frequency than the frequency corresponding with the graphics content type. If the first amount of printed test pages successively show less print defects, the frequency of the test pages may be lowered again to the regular frequency corresponding to the graphics content type. The first amount may depend on the amount of print defects as well as on the kind of print defects. The first amount may be predetermined and stored in memory of the sheet scheduler 373.

According to an embodiment the sheet scheduler 373 comprises memory containing a frequency of printing test pages per content type in order to establish the time schedule for printing the test pages per content type. FIG. 4 shows for example a look up table 400 for an established content type 401 and a corresponding test page frequency 402 or print interval 403 expressed in sheets 41 which is to be used to schedule the test pages of such a content type 401. An entry of a content type named “Mixed text/graphics” may be part of the look up table based on a fifty-fifty distribution of text and graphics on the page. In case of another distribution the frequencies of the content types “text only” and “graphics” for a page at which text and graphics objects are detected may be used to calculate a corresponding proportional frequency for the corresponding test page.

In a third step S3 in FIG. 2 scheduled print job pages are printed on sheets 41 according to the print job queue and test pages are printed on sheets 41 at a print interval or at a frequency determined by the sheet scheduler 373 in step S2.

The method ends in an end point B.

Steps S1-S3 may be repeated when a new print job is received by the print job receiving section 371 of the controller 37.

The described embodiments of the printing system according to the invention may be varied upon and/or combined according to skills of a skilled person in the art.

The described embodiments of the method according to the invention may be varied upon and/or combined according to the skills of a skilled person in the art.

The skilled person will recognise that other embodiments are possible within the scope of the appended claims.

1. A printing system adapted to carry out print jobs on the basis of print job content supplied to a controller of the printing system and to discharge printed job pages at a first job output, the printing system comprising a sheet scheduler configured to schedule test pages during the printing of the print jobs and to adapt a time schedule for printing the test pages to a content type of each page of each print job,
wherein the sheet scheduler is configured to adapt the time schedule for printing the test pages to a media type of each page of each print job, and
the sheet scheduler is configured to schedule a first number of job pages of a first media type and consecutively a second number of job pages of a second media type and to schedule within the first number of job pages a test page of the second media type.

2. The printing system according to claim 1, wherein the controller is configured to determine a content type for each page of each print job by means of the print job properties.

3. The printing system according to claim 1, wherein the controller comprises a raster image processor for rasterizing the print jobs and the controller is configured to determine a content type for each page of each print job by means of rasterized images of the pages of the print job.

4. The printing system according to claim 1, wherein the printing system comprises an inline vision system positioned between the print engine and the second job output and configured to capture images of the printed job pages and printed test pages, and the controller is configured to analyse content of captured images of recently printed job pages in order to determine a content type of printed job pages scheduled between recently printed test pages and the sheet scheduler is configured to use the determined content type of the printed job pages scheduled between the recently printed test pages to determine the time schedule for next test pages.

5. The printing system according to claim 1, wherein the sheet scheduler is configured to determine a moment in time to start with printing test pages according to the determined time schedule by taking into account a time period which is needed to determine the content type of the print jobs and to prepare correcting actions due to the analysis of the content of the captured images before an actual printing of the job pages with a new content type starts.

6. The printing system according claim 1, wherein the controller is configured to determine a content type of a job page by means of at least one color of content of the job page.

7. The printing system according to claim 4, wherein the sheet scheduler is configured to determine the time schedule for printing the test pages by taking into account an amount of detected print defects from images captured from the already printed test pages.

8. The printing system according to claim 1, wherein the sheet scheduler comprises memory containing a frequency of printing test pages per content type in order to establish the time schedule for printing the test pages per content type.

9. The printing system according to claim 1, the printing system comprising a user interface adapted to receive a dedicated frequency of printing test pages for each content type, the dedicated frequency entered by a user of the printing system at the user interface.

10. The printing system according to claim 1, wherein the printing system comprises a second job output configured to discharge printed test pages.

11. Method for scheduling test pages on a printing system adapted to carry out print jobs on the basis of print job data supplied to a controller of the printing system and to discharge printed job pages at a first job output, the printing system comprising a sheet scheduler configured to schedule test pages during the printing of the print jobs, the method comprising the steps of
determining a content type of each page of each print job by the controller,
determining a time schedule for printing the test pages by the sheet scheduler, the time schedule based on the determined content type of each page of each print job, and
printing the test pages according to the determined time schedule by the printing system (1), wherein
the method comprises the steps of
adapting the time schedule for printing the test pages to a media type of each page of each print job,
scheduling a first number of job pages of a first media type and consecutively a second number of job pages of a second media type, and
scheduling within the first number of job pages a test page of the second media type.

12. A non-transitory recording medium comprising computer-executable program code configured to instruct a computer to perform a method according to claim 11.
